(19) United States
(12) Patent Application Publication
(10) Pub. No.: US 2026/0080256 A1
(43) Pub. Date: Mar. 19, 2026

(54) LAGRANGIAN RELAXATION DEEP REINFORCEMENT LEARNING SYSTEMS AND METHODS FOR WEAKLY COUPLED MARKOV DECISION PROCESSES

(71) Applicant: Hitachi, Ltd., Tokyo (JP)

(72) Inventors: Ibrahim EL SHAR, Sunnyvale, CA (US); Haiyan WANG, Fremont, CA (US); Chetan GUPTA, Sunnyvale, CA (US)

(21) Appl. No.: 18/886,832

(22) Filed: Sep. 16, 2024

(51) Int. Cl. G06N 3/092

(52) U.S. Cl. CPC G06N 3/092

(57) ABSTRACT

Systems and methods described herein train a deep reinforcement learning agent to solve weakly coupled Markov decision processes using Lagrangian relaxation in a model-free setting. By relaxing linking constraints separate subproblems may be obtained that are easier to solve when considered individually. In embodiments, this is accomplished by collecting experience tuples from a main problem, decomposing them into subproblems, and introducing Lagrangian multipliers to manage linking constraints. Transition experiences are stored in a replay buffer and Lagrangian action-values learn for each subproblem via DQN using a relaxed Bellman equation. The method includes estimating the overall Lagrangian action-value function, solving an optimization problem over Lagrangian multipliers, and choosing actions greedily. Various embodiments iteratively improve a policy and integrate subproblem solutions into a main problem solution to apply a policy that has been learned by subagents using a single deep Q-network, in real-world scenarios without prior knowledge of the environment.

### BACKGROUND

### Field

The present disclosure is generally directed to information handling systems, and more specifically, to deep reinforcement learning (RL) systems and methods for weakly coupled Markov decision processes (WCMDPs).

### Related Art

RL has contributed to a range of sequential decision-making and control problems such as games, robotic manipulation, chemical reactions, efficient and targeted COVID-19 border testing, and fine-tuning ChatGPT. Despite these notable successes, implementing RL in practical setting remains challenging due to the high cost of interactions in real-world settings. A critical question is how to improve the sample efficiency of RL to build more deployable systems. One promising approach is to incorporate additional structural information about the problem into the learning process.

The tailored RL embodiments herein leverage the inherent structure found in WCMDPs-a broad class of sequential decision-making problems. A WCMDP consists of multiple subproblems that are independent except for a coupling constraint on the subproblem actions. In general, these problems are very difficult to solve using RL since the state and action spaces grow exponentially with the number of subproblems. Examples of WCMDPs include supply chain management, recommender systems, EV charging, online advertising, revenue management, and stochastic job scheduling.

Traditional approaches to solve WCMDPs involve Lagrangian relaxation of the dynamic program and approximate linear programming. However, these approaches require knowledge of the system's transition and rewards functions which oftentimes are not available and or difficult to estimate.

Some approaches use RL in the context of restless multi-armed bandits (RMABs), where there are two actions (“active” or “passive”) for each subproblem (also known as “project” or “arm”), under a budget constraint on the number of active arms at any given time. This is a special case of a WCMDP with two actions per subproblem and a single budget constraint. A common solution for RMABs is the Whittle index policy, which ranks arms by their “marginal productivity.” The Whittle index policy is asymptotically optimal under a condition known as indexability. However, verifying the indexability condition and other technical condition necessary for asymptotic optimality remains challenging. Relying on the Whittle index policy in real-world problems can be problematic due to these hard-to-verify technical conditions, which, if unmet, can undermine the computational robustness and the heuristic's original intuitive motivation. While some approaches apply RL directly to the Lagrangian relaxation of the problem to obtain a “Lagrange policy,” these approaches are limited to tabular RL, which limits their use to small-scale problems.

In contrast, embodiments herein integrate Lagrangian relaxation with deep reinforcement learning, which enables the handling of large-scale problems without the need for an indexability condition, thus applicable to any WCMDP.

One existing approach uses a Lagrangian relaxation approach to generate an upper bound on the optimal action value function. Such upper bounds guide the optimization of the Deep Q-Network (DQN) model by integrating a penalty term in the loss function in the training process to penalize high-Q value estimates. This approach is much more complex than the embodiments presented herein, as it requires two Q-networks instead of one. Moreover, by learning the Lagrangian policy, various embodiments allow for the full exploitation of the subproblems' decomposition to achieve efficient learning and faster convergence. Exemplary relaxations of WCMDPs may be performed in several ways, including approximate linear programming (ALP), network relaxation, and Lagrangian relaxation. The Lagrangian relaxation embodiments herein relax the linking constraints on the action space by introducing a penalty in the objective, advantageously eliminating the need to for knowledge of the environment dynamics and utilizing a model-free approach.

### SUMMARY

In some aspects of the disclosure, a method for training an RL agent to solve weakly coupled WCMDPs comprises: at a deep RL agent, for each subproblem in a set of subproblems associated with a main problem, inputting weights, states, and a set of Lagrangian multipliers into a DQN to train the DQN to learn a Lagrangian action-value, e.g., in a model-free setting; combining the subproblems to obtain an upper bound of the Lagrangian action-values; using a greedy policy associated with the upper bound to determine an action; in response to observing a transition experience associated with the action, storing experience tuples from interactions with the main problem in a replay buffer; sampling both a subset of the experience tuples and a random Lagrangian multiplier from the set of Lagrangian multipliers; using the random Lagrangian multiplier to decompose the subset into subproblems to obtain target values for each subproblem; using the target values to train the DQN, which may be updated by using weights in gradient descent based on the experience tuples and the Lagrangian multipliers; and performing a gradient descent operation to update the DQN. A learned policy can then be used to make decisions in a real-world scenario without prior knowledge of an environment.

In some aspects, the method further comprises using the random Lagrangian multiplier to incorporate linking constraints of the subproblems into an objective function, and a penalty may be applied for constraint violations through Lagrangian relaxation.

In some aspects, the method further comprises using the Lagrangian action-values to estimate an overall Lagrangian action-value function.

In some aspects, the techniques described herein relate to a non-transitory computer-readable medium for storing instructions for executing a process, the instructions including: for each subproblem in a set of subproblems associated with a main problem, inputting weights, states, and a set of Lagrangian multipliers into a Deep Q-Network (DQN) to train the DQN to learn a Lagrangian action-value; combining the subproblems to obtain an upper bound of the Lagrangian action-values; using a greedy policy associated with the upper bound to determine an action; in response to observing a transition experience associated with the action, storing experience tuples from interactions with the main problem in a replay buffer; sampling both a subset of the experience tuples and a random Lagrangian multiplier from the set of Lagrangian multipliers; using the random Lagrangian multiplier to decompose the subset into subproblems to obtain target values for each subproblem; using the target values to train the DQN; and performing a gradient descent operation to update the DQN.

Aspects of the present disclosure can involve a system, which, for each subproblem in a set of subproblems associated with a main problem, can involve means for inputting weights, states, and a set of Lagrangian multipliers into a Deep Q-Network (DQN) to train the DQN to learn a Lagrangian action-value; means for combining the subproblems to obtain an upper bound of the Lagrangian action-values; means for using a greedy policy associated with the upper bound to determine an action; in response to observing a transition experience associated with the action, means for storing experience tuples from interactions with the main problem in a replay buffer; means for sampling both a subset of the experience tuples and a random Lagrangian multiplier from the set of Lagrangian multipliers; using the random Lagrangian multiplier to decompose the subset into subproblems to obtain target values for each subproblem; means for using the target values to train the DQN in a model-free setting; and means for performing a gradient descent operation to update the DQN.

### BRIEF DESCRIPTION OF DRAWINGS

FIG. 1 illustrates an exemplary supply chain distribution chain, according to various embodiments of the present disclosure.

FIG. 2 illustrates decomposing a problem into simpler problems using Lagrangian relaxation and a set of subagents that learn using a single Q-Network, according to various embodiments of the present disclosure.

FIG. 3 illustrates using a single network to learn Lagrangian action-values of subproblems, according to various embodiments of the present disclosure.

FIG. 4 illustrates a Lagrangian DQN training process according to various embodiments of the present disclosure.

FIG. 5 illustrates the performance of Lagrangian DQN and standard DQN during training in terms of total reward for a supply chain example, according to various embodiments of the present disclosure.

FIG. 6. illustrates a Lagrangian DQN deployment process according to various embodiments of the present disclosure.

FIG. 7 is an exemplary output of a trained Lagrangian DQN agent in a supply chain problem, according to various embodiments of the present disclosure.

FIG. 8 is a flowchart illustrating an exemplary process for training an RL agent to solve weakly coupled WCMDPs, in accordance with various embodiments of the present disclosure.

FIG. 9 illustrates an example computing environment with an example computer device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

RL provides a general learning framework for solving a wide range of problems without relying on extensive domain knowledge or restrictive assumptions. However, RL requires substantial experience to converge to good policies, which makes RL challenging to implement in real-world problems. Weakly coupled MDPs are a broad class of sequential decision-making problems that include many business themes, such as supply chain management, job/production scheduling, recommendation systems, online advertising, and marketing. These problems are typically difficult to solve using naïve RL. Embodiments herein learn Lagrangian policies to handle general WCMDPs in a fully model-free, deep RL setting, providing systems and methods for solving a wide variety of realistic problems.

Considering an infinite horizon WCMDP that consists of N subproblems, indexed by i∈{1, . . . , N}, the WCMDP is defined by the state space

$$𝒮 = {⊗}_{i = 1}^{N}$$

[symbol]

and the finite action space

$$𝒜 = {⊗}_{i = 1}^{N}$$

[symbol]

, where [symbol] and [symbol] , are the state and action spaces of subproblem i, respectively. In each period, the decision maker observes the state s=(s₁, . . . , s_{N}) and selects an action aᵢ∈ [symbol] for all subproblems. The problem is subject to a set of linking constraints given by

$${\sum }_{i = 1}^{N} {d}_{i} ( {s}_{i} , {a}_{i} ) \leq b ,$$

where dᵢ (sᵢ, aᵢ), b∈ [symbol] . The feasible set of actions, given by all the actions that satisfy the set of linking constraints, is denoted by:

$$𝒜 ( s ) = \{ a ∈ 𝒜 : {\sum }_{i = 1}^{N} {d}_{i} ( {s}_{i} , {a}_{i} ) \leq b \} \qquad Eq . ( 1 )$$

The state transition distribution p factors across the subproblems transitions distribution pᵢ given (s, a):

$$p ( {s}^{′} \vert s , a ) = {\prod }_{i = 1}^{N} {p}_{i} ( {s}_{i} , {a}_{i} ) .$$

Denoting rᵢ(sᵢ, aᵢ) as the reward of subproblem i, and letting

$$r ( s , a ) = {\{ {r}_{i} ( {s}_{i} , {a}_{i} ) \}}_{i = 1}^{N} ,$$

the reward of all subproblems is given by:

$$r ( s , a ) = {\sum }_{i = 1}^{N} {r}_{i} ( {s}_{i} , {a}_{i} )$$

Assuming r∈[Rₘᵢₙ, Rₘₐₓ], a policy π is a mapping from the state space [symbol] to the action space [symbol] . A policy π(s) is called feasible if π(s)∈ [symbol] (s), ∀s∈ [symbol] . Given a discount factor γ, the action-value function of a policy π is denoted by:

$${Q}^{π} ( s , a ) = E [ {\sum }_{t = 0}^{∞} {γ}^{t} r ( {s}_{t} , {a}_{t} ) \vert π , {s}_{0} = s , {a}_{0} = a ]$$

The goal of the decision-maker is to find a feasible optimal policy π* that maximizes:

$${V}^{π} ( s ) = {Q}^{π} ( s , π ( s ) )$$

The optimal value and action value functions are given by

$${V}^{*} ( s ) = {max}_{π} {V}^{π} ( s ) and {Q}^{*} ( s , a ) = {max}_{π} {Q}^{π} ( s , a ) ,$$

respectively. The optimal policy selects actions according to π*(s)=argmaxₐ Q*(s, a). The optimal action value function can be expressed by the Bellman equation:

$${Q}^{*} ( s , a ) = r ( s , a ) + γ E [ {max}_{a ′ ∈ 𝒜 ( s ′ )} {Q}^{*} ( {s}^{′} , {a}^{′} ) ] \qquad Eq . ( 2 )$$

In this document, the terms “experience,” “transition experience,” and “experience tuple” are used interchangeably.

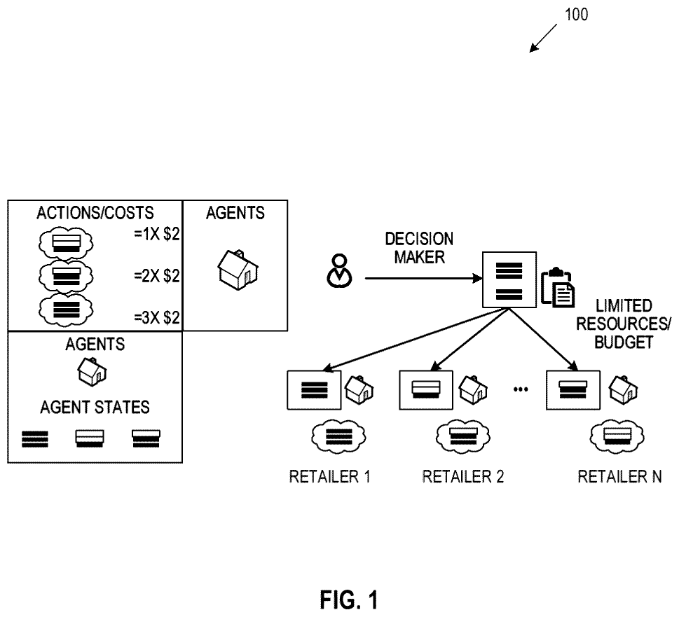

FIG. 1 illustrates an exemplary supply chain distribution chain, according to various embodiments of the present disclosure. Considering problem involving a two-echelon supply chain 100 comprising a warehouse and N retailers depicted in FIG. 1, the warehouse and the retailers have limited storage capacities denoted by b and {C₁, . . . , C_{N}}, respectively. In each period, the decision-maker needs to make inventory replenishment decisions for each retailer while taking into consideration the limited stock available at the warehouse. The goal is to find an ordering policy that minimizes the total cost, which includes the ordering, holding, and lost sales costs.

### Lagrangian Relaxation

Finding an exact solution to the Bellman equations in Eq. (2) poses computational challenges. A commonly used approximate solution method is Lagrangian relaxation. The initial step involves relaxing the linking constraints

$${\sum }_{i = 1}^{N} {d}_{i} ( {s}_{i} , {a}_{i} ) \leq b$$

and introducing a corresponding penalty into the objective function using nonnegative Lagrange multipliers, represented by ∈

$${ℝ}_{+}^{L} .$$

This leads to the formulation of the relaxed Bellman equations:

$${Q}^{λ} ( s , a ) = r ( s , a ) + {λ}^{T} [ b - {\sum }_{i = 1}^{N} d ( {s}_{i} , {a}_{i} ) ] + {γ}^{E} [ {max}_{{a}^{′} ∈ 𝒜} {Q}^{λ} ( {s}^{′} , {a}^{′} ) ] \qquad Eq . ( 3 )$$

The following results establish that for any nonnegative penalty vector λ, the Lagrangian action value function Q^{λ}(s, a) serves as an upper bound on Q*(s, a) and that the Lagrangian dynamic program Eq. (3) can be decomposed across subproblems.

### Proposition 1.

For any by λ∈

$${ℝ}_{+}^{L} ,$$

the following holds for all s∈ [symbol] and a∈ [symbol] (s):
i)

$${Q}^{λ} ( s , a ) \geq Q ⋆ ( s , a )$$

ii)

$${Q}^{λ} ( s , a ) = r ( s , a ) + {λ}^{T} [ b - {\sum }_{i = 1}^{N} d ( {s}_{i} , {a}_{i} ) ] + {γ}^{E} [ {max}_{{a}^{′} ∈ 𝒜} {Q}^{λ} ( {s}^{′} , {a}^{′} ) ] \qquad Eq . ( 4 )$$

where

$${Q}_{i}^{λ}$$

(sᵢ,aᵢ) is given by:

$${Q}_{i}^{λ} ( {s}_{i} , {a}_{i} ) = {r}_{i} ( {s}_{i} , {a}_{i} ) - {λ}^{T} {d}_{i} ( {s}_{i} , {a}_{i} ) + γ E [ {max}_{{a}_{i}^{′} ∈ {𝒜}_{i}} {Q}_{i}^{λ} ( {s}_{i}^{′} , {a}_{i}^{′} ) ] \qquad Eq . ( 5 )$$

The Lagrangian dual problem involves finding the tightest upper bound by optimizing over the Lagrangian multipliers λ:

$${Q}^{{λ}^{*}} ( s , a ) = {min}_{λ} {Q}^{λ} ( s , a ) \qquad Eq . ( 6 )$$

Embodiments herein involve training a deep RL agent that utilizes a Lagrangian relaxation approach combined with Deep Q-Networks (DQNs) to achieve fast and efficient learning on a wide set of real-world problems without the knowledge of the environment dynamics, thus operating in a model-free manner. A main concept is to break down a complex problem into simpler and more manageable subproblems to enable more scalable and practical RL solutions. The systems and methods herein enable the RL agent to train on these subproblems and then combine their solutions to learn effective policies. To achieve this, the experience of the main problem is decomposed, and a single Q-network is trained on the decomposed experiences of all subproblems. A Lagrangian relaxation approach may then be applied using a set of Lagrangian multipliers. When taking actions, the agent acts greedily with respect to the Lagrangian action-value function, which takes into consideration the action-values of the subproblems.

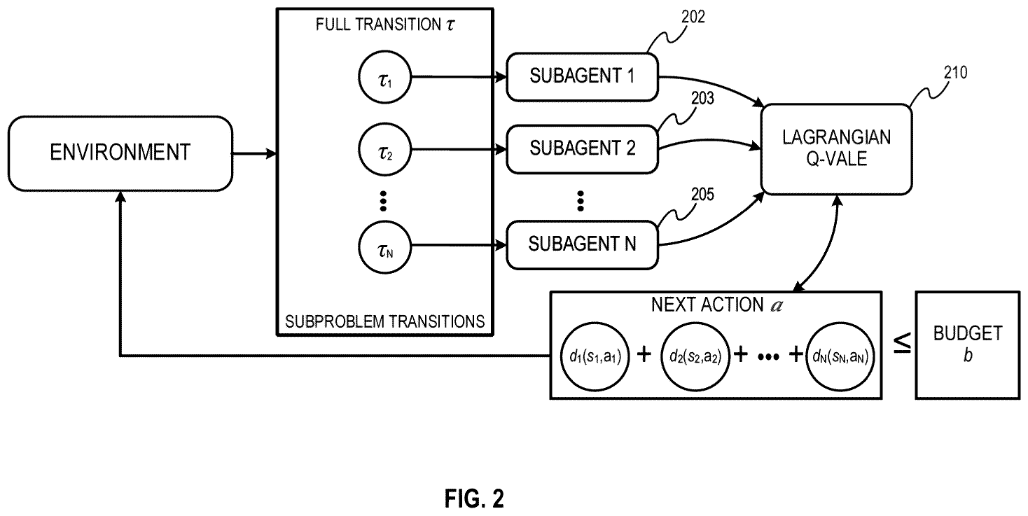

In embodiments, Lagrangian DQNs integrate Lagrangian relaxation with DQN to learn the Lagrangian policy that is greedy with respect to Q^{λ}*. FIG. 2 illustrates decomposing a problem into simpler problems using Lagrangian relaxation and a set of subagents that learn using a single Q-Network, according to various embodiments of the present disclosure. As depicted, subagents 202-205 learn using single Q-Network 210, as illustrated in FIG. 2.

To accomplish this, the Lagrangian action-values Q^{λ}*(sᵢ, aᵢ) for each subproblem are first learned via DQN by using Eq. (5). These values are then used to estimate Q^{λ}* following Eq. (4) before solving the optimization problem in Eq. (6) to obtain Q^{λ}*. In practice, Eq. (6) may be solved by restricting the optimization over λ to a finite set of Lagrangian multipliers Λ={λ1:1∈ [symbol] , 0≤λ≤λ̅.}. The following approach establishes an upper bound on the value of λ that minimizes Eq. (6). This upper bound may then be used to set the value λ̅.

### Proposition 1

For any subproblem i, suppose that there is an action

$${a}_{i}^{0}$$

such that

$${d}_{i} ( {s}_{i} , {a}_{i}^{0} ) = 0 and {r}_{i} ( {s}_{i} , {a}_{i}^{0} ) \geq 0.$$

Let

$${\underline{d}}_{i} = {min}_{{s}_{i} , {a}_{1} \neq {a}_{1}^{0}} {d}_{i} ( {s}_{i} , {a}_{i} ) .$$

### Then

$$λ \leq \frac{{R}_{max}}{( 1 - γ ) {min}_{i} {\underline{d}}_{i}} .$$

Proof: Fix a subproblem i. Inspection of Eq. (5) reveals that if at any time step, λdᵢ is greater than any possible future reward R_{i,max}/(1−γ), then the optimal policy will choose action

$${a}_{i}^{0}$$

and still achieve a positive discounted sum of rewards. Since it is known that the policy that always choose

$${a}_{i}^{0}$$

is merely a feasible policy and not necessarily optimal, it is suboptimal to choose a value of λ that is greater than R_{i,max}/(1−γ)dᵢ. This result follows since R_{i,max}≥R_{i,max} for all i.

Before formally describing an exemplary process, the below assumption on the observability of the linking constraints is restated.

### Assumption 1 (Linking Constraints Observability)

The right-hand side b of the linking constraints and dᵢ(sᵢ, aᵢ) are observable for all subproblems i and sᵢ∈ [symbol] and aᵢ∈ [symbol] . This assumption ensures that the agent possesses sufficient information to make feasible actions at each time step. This assumption naturally holds. For example, in the supply chain problem, the total number of orders from retailers should be less than the observable inventory at the warehouse.

### Lagrangian DQN Process

In embodiments, Lagrangian DQN comprises two main steps:
1. Lagrangian Q^{λ*}-value construction:

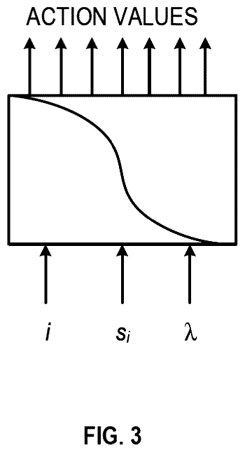

As illustrated in FIG. 3, a single network with weights θ may be used to learn the Lagrangian action-value of each subproblem Q (i, λ, sᵢ, aᵢ; θ) and for all λ∈Λ. Similar to DQN, a target network, Q⁻(i, λ, sᵢ, aᵢ; θ⁻), may be used which has a similar architecture to Q but with weights θ⁻ that we set to θ⁻=θ, every C periods. Given the subproblems' action-value function, Q(i, λ, sᵢ, aᵢ; θ), the Lagrangian action-value of all subproblems and the best upper bound are computed for all λ∈Λ and a∈

[symbol]

$${Q}^{λ} ( s , a ; θ ) = \frac{{λ}^{T} b}{1 - y} + {\sum }_{i}^{N} Q ( i , λ , {s}_{i} , {a}_{i} ; θ ) \qquad ( 7 )$$

$$and$$

$${Q}^{{λ}^{*}} ( s , a ; θ ) = {min}_{λ ∈ Λ} {Q}^{λ} ( s , a ; θ ) \qquad Eq . ( 8 )$$

2. Action-selection: The agent may choose an action using an e-greedy policy with respect to Q^{λ}* and store the observed transition (s, a, d, r, s′) in a replay buffer D.

Network training: First, sample a batch of A and experience tuples {(s, a, d, r, s′)} of size K, from a replay buffer D. Decomposing the experience into {(sᵢ, aᵢ, dᵢ, r, s)′} for all i∈{1, . . . , N} and constructing the target value for each subproblem yields

$${y}_{i}^{λ} = {r}_{i} ( {s}_{i} , {a}_{i} ) - λ {d}_{i} ( {s}_{i} , {a}_{i} ) + γ {max}_{{a}_{i}^{′}} {Q}^{-} ( i , λ , {s}_{i}^{′} , {a}_{i}^{′} ; {θ}^{-} ) .$$

Finally, the network is trained by performing a gradient descent step on

$$L ( θ ) = \frac{1}{K} {\sum }_{\{ ( {s}_{i} , {a}_{i} , {d}_{i} , {r}_{i} , {s}_{i}^{′} ) \}} {\sum }_{i = 1}^{N} {( {y}_{i}^{λ} - Q ( i , λ , {s}_{i} , {a}_{i} ; θ ) )}^{2}$$

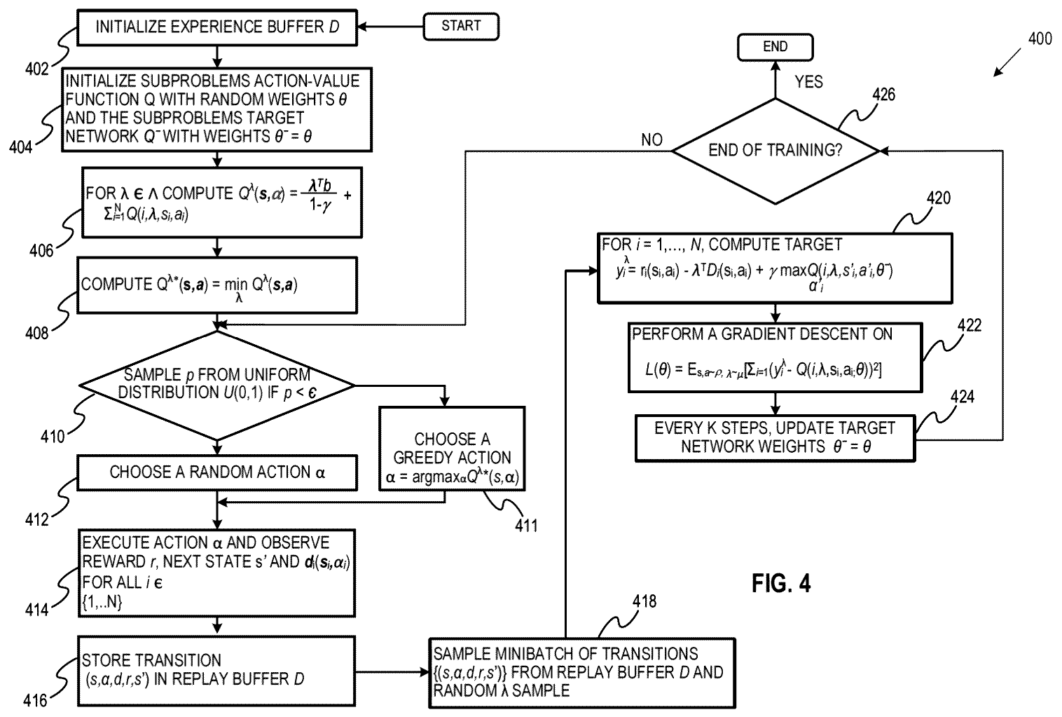

An exemplary process is shown below and in corresponding FIG. 4.

### Process 1 (Lagrangian DQN)

```
Input: Initialized replay buffer [symbol]   , Lagrangian multipliers set A, subproblems Q-network
θ & θ⁻ = θ
$Output : Approximation \{ {Q}_{n}^{λ} \}$
for n = 0, 1, 2, ... do
    Find the best upper bound:
    $For λ ∈ Λ and a ∈ 𝒜 ( {s}_{n} ) find {Q}_{n}^{λ} ( {s}_{n} , a )$
${Q}_{n}^{λ} ( s , a ) = \frac{{λ}^{T} b}{1 - γ} + {\sum }_{i = 1}^{N} Q ( i , λ , {s}_{i} , {a}_{i} ; θ ) .$
    $Set {Q}_{n}^{λ} ( {s}_{n} , a ) = {min}_{λ ∈ Λ} {Q}_{n}^{λ} ( {s}_{n} , a )$
$Choose an action {a}_{n} via some behavior policy ( e . g . , ∈ - greedy ( {Q}_{n}^{λ *} ) ) observe the$
transition experience and store (sₙ, aₙdₙ, rₙ, sₙ₊₁) in [symbol]   .
    Update the network:
    Sample a minibatch of transitions τ from [symbol]    along with random λ.
    for i = 1, ... , N do
        Compute targets [symbol]    as per
        ${𝒴}_{i}^{λ} = {r}_{i} ( {s}_{i} , {a}_{i} ) - {λ}^{T} {d}_{i} ( {s}_{i} , {a}_{i} ) + γ {max}_{{a}_{i}^{′}} {Q}^{-} ( i , λ , {s}_{i} , {a}_{i} ; {θ}^{-} ) ,$
        Perform a gradient descent step on
$L ( θ ) = {𝔼}_{{s}_{i} , a ∼ ρ , λ ∼ μ} [ {\sum }_{i = 1}^{N} {( {𝒴}_{i}^{λ} - Q ( i , λ , {s}_{i} , {a}_{i} ; θ ) )}^{2} ]$
    end for
end for
```

FIG. 4 illustrates a Lagrangian DQN training process according to various embodiments of the present disclosure. Exemplary process 400 uses a single network to learn Lagrangian action-values. Once an experience buffer is initialized, at step 402 of process 400, subproblems are initialized, at step 404, an upper bound is computed at step 406 and 408. At step 410, a random variable p is sampled from a uniform distribution and then compared to a value E. If p<ϵ, then at step 412 a random action is chosen. Otherwise, a greedy action is chosen at step 411. Once the action is executed, at step 414, and the reward and next states are observed, the transitions are stored in the replay buffer at step 416. At step 418, a minibatch of transitions from the replay buffer and a random Lagrange multiplier sample are sampled. At step 420, targets are computed. At step 422 a gradient descent is performed based on the experience tuples and the Lagrangian multipliers. At step 426, every K steps, target network weights are updated. If, at step 420, it is determined that training has not ended, process 400 returns to step 410 to resume sampling a state transition distribution; otherwise process 400 ends.

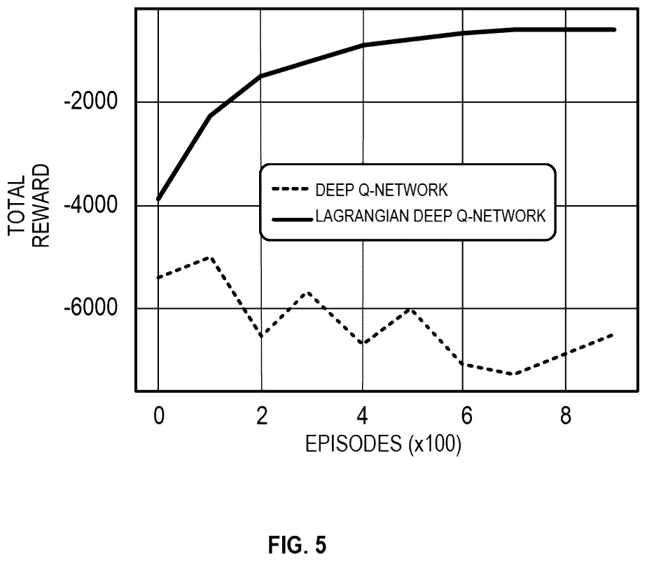

FIG. 5. illustrates the performance of Lagrangian DQN and standard DQN during training in terms of total reward for a supply chain example, according to various embodiments of the present disclosure. Lagrangian DQN is tested on the inventory management problem (supply chain example in FIG. 1) that consists of a warehouse that supplies four retailers. The retailers are facing stochastic demands and need to optimize their inventory levels in each period by ordering inventory from the warehouse. In total, there are 46656 actions. Results demonstrate that Process 1 outperforms Deep Q-Network algorithms by a significant margin in terms of total sum of rewards (negative total costs).

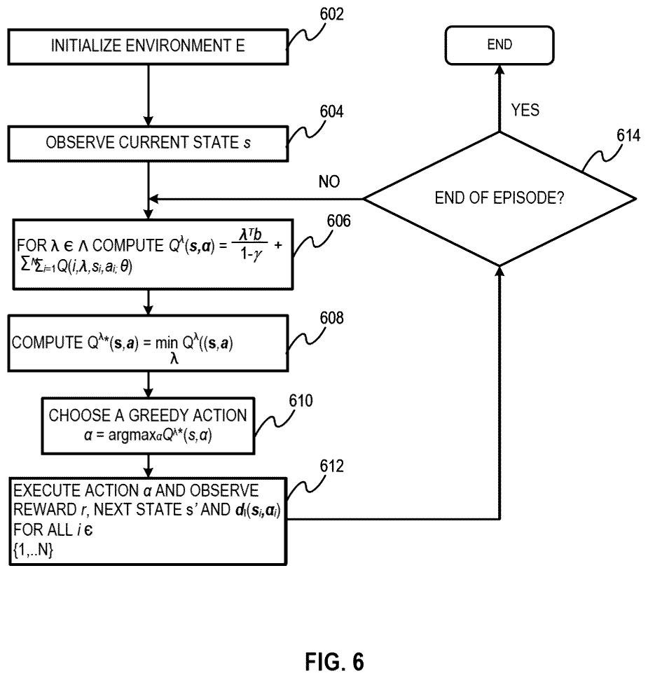

FIG. 6. illustrates a Lagrangian DQN deployment process according to various embodiments of the present disclosure. As shown, the deployment steps of Lagrangian DQN are similar to that of DQN. In embodiments, once environment E is initialized (602), in each period, after observing (604) the state s, given by the environment, a greedy action is taken (610) based on the computed (606) best Lagrangian action-value function Q^{λ}* as per Eqs. (6) and (7).

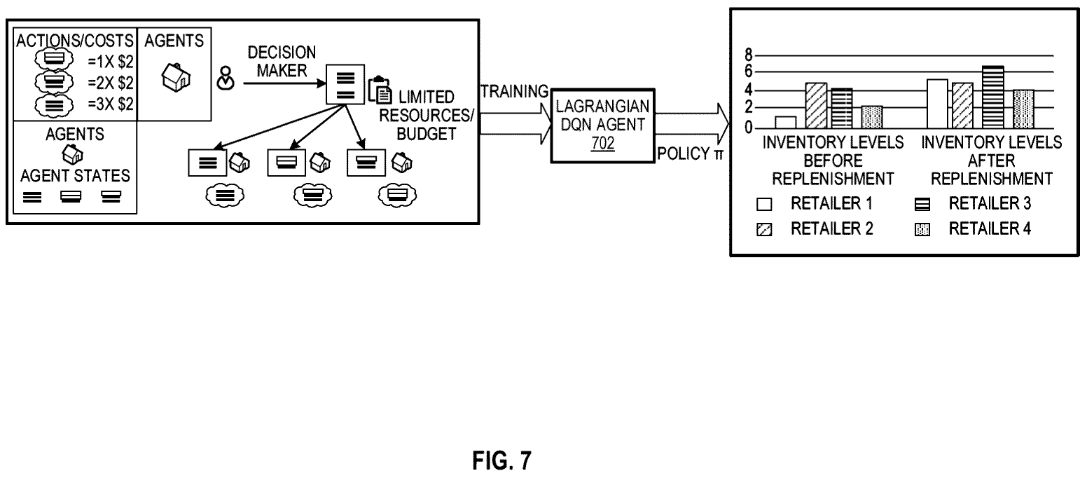

FIG. 7 is an exemplary output of a trained Lagrangian DQN agent in a supply chain problem with a warehouse and four retailers. The exemplary problem statement is to “learn an inventory replenishment policy that minimizes the cost of the supply chain.” Lagrangian DQN agent 702 learns a policy that maps the current inventory levels to inventory ordering quantities. Considering, for example, a problem with four retailers having current inventory levels given by (1,5,4,2) for retailer 1,2,3, and 4, respectively, the warehouse that supplies the retailers has a capacity of b=10 units. The learned policy will map the inventory levels (s1, s2, s3, s4) to ordering quantities (a1, a2, a3, a4) from the warehouse such that a1+a2+a3+a4≤b: It (1,5,4,2)-(4,0,3,2)

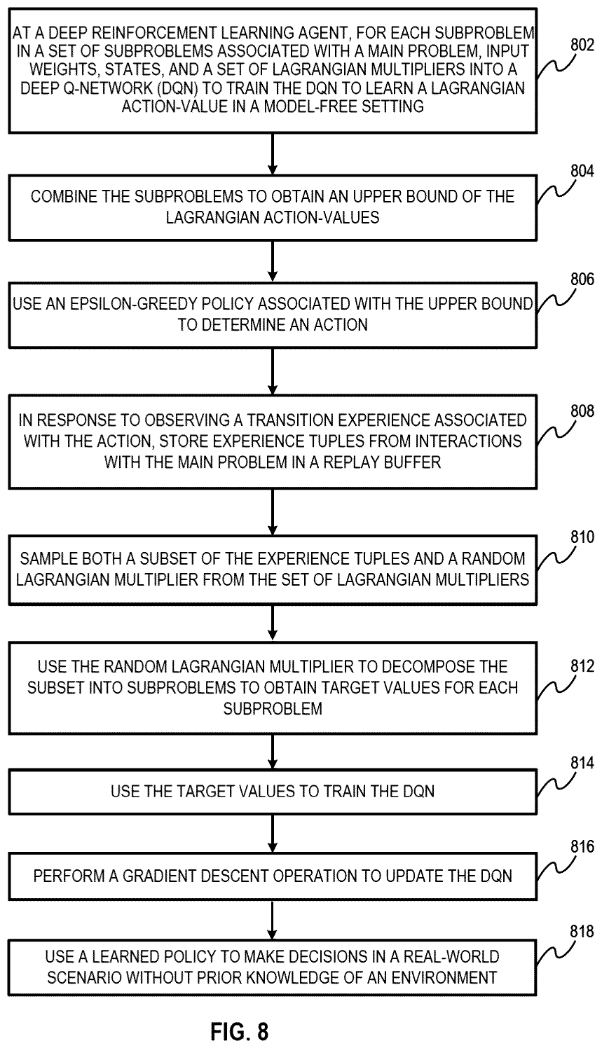

FIG. 8 is a flowchart illustrating an exemplary process for training an RL agent to solve WCMDPs, in accordance with various embodiments of the present disclosure. In embodiments, process 800 may start at a deep RL agent, when for each subproblem in a set of subproblems associated with a main problem, weights, states, and a set of Lagrangian multipliers are input into a DQN to train the DQN to learn a Lagrangian action-value.

At step 804, the subproblems are combined to obtain an upper bound of the Lagrangian action-values. The Lagrangian action-values may be used to estimate an overall Lagrangian action-value function.

At step 806, an e-greedy policy associated with the upper bound is used to determine an action.

At step 808, in response to observing a transition experience associated with the action, experience tuples from interactions with the main problem are stored in a replay buffer.

At step 810, both a subset of the experience tuples and a random Lagrangian multiplier from the set of Lagrangian multipliers is sampled. The random Lagrangian multiplier may be used to incorporate linking constraints of the subproblems into an objective function. A penalty may be applied for constraint violations through Lagrangian relaxation.

At step 812, the random Lagrangian multiplier is used to decompose the subset into subproblems to obtain target values for each subproblem.

At step 814, the target values are used to train the DQN.

At step 816, a gradient descent operation is performed to update the DQN. DQN weights may be updated through gradient descent based on the experience tuples and the Lagrangian multipliers.

Finally, at step 818, a learned policy is used to make decisions in a real-world scenario without prior knowledge of an environment.

One skilled in the art shall recognize that: (1) certain steps may optionally be performed; (2) steps may not be limited to the specific order set forth herein; (3) certain steps may be performed in different orders; and (4) certain steps may be done concurrently.

It is noted that although the invention is generally described in the context of supply chain management, it is understood that this is not intended to limit the scope of the present disclosure to such embodiments as the systems and methods for training an RL agent to solve WCMDPs described herein may be used in any other suitable context.

Embodiments herein aim to learn Lagrangian policies to tackle general WCMDPs in a fully model-free deep RL setting. Their systematic approach enables solving a wide variety of practical problems that include many business applications, such as supply chain management, job/production scheduling, recommendation systems, online advertising, and marketing. The implementation into real-world scenarios offers immense potential for business growth. Lagrangian DQN eliminates the need for assumptions on WCMDPs, such as indexability, making it broadly applicable and easier to implement.

Empirical results show that, unlike traditional RL algorithms, Lagrangian DQN enables RL agents to learn effective policies with substantially less experience. Unlike traditional RL algorithms, Lagrangian DQN is scalable and capable of solving large-scale sequential decision-making problems with extensive state and action spaces, surpassing the limitations of traditional approaches.

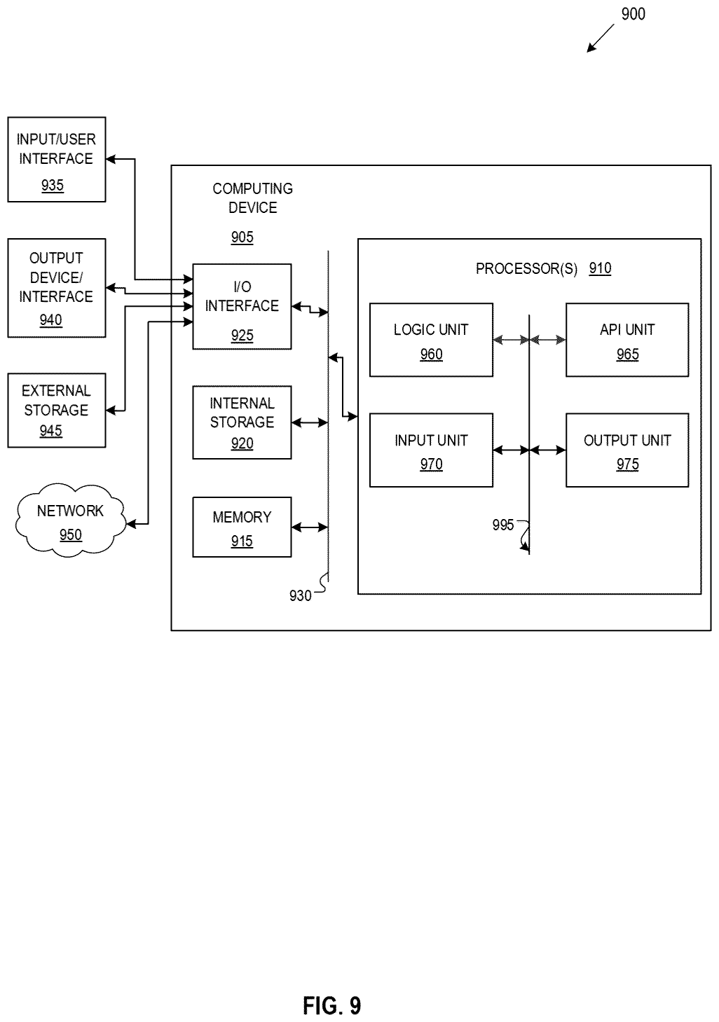

FIG. 9 illustrates an example computing environment with an example computer device suitable for use in some example implementations. Computer device 905 in computing environment 900 can include one or more processing units, cores, or processors 910, memory 915 (e.g., RAM, ROM, and/or the like), internal storage 920 (e.g., magnetic, optical, solid-state storage, and/or organic), and/or I/O interface 925, any of which can be coupled on a communication mechanism or bus 930 for communicating information or embedded in the computer device 905. I/O interface 925 is also configured to receive images from cameras or provide images to projectors or displays, depending on the desired implementation.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configurations. Computer device 905 or any connected computer device can function as, providing services of, or referred to as a server, client, thin server, general machine, special-purpose machine, or another label.

I/O interface 925 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, a satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, and output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

Processor(s) 910 can be configured to execute a method or computer instructions which can involve, for each subproblem in a set of subproblems associated with a main problem, inputting weights, states, and a set of Lagrangian multipliers into a DQN to train the DQN to learn a Lagrangian action-value, e.g., in a model-free setting, as described, for example, with respect to FIG. 4. Processor(s) 910 can further be configured to combine the subproblems to obtain an upper bound of the Lagrangian action-values; use a greedy policy associated with the upper bound to determine an action; and, in response to observing a transition experience associated with the action, store experience tuples from interactions with the main problem in a replay buffer. Processor(s) 910 can further be configured to sample both a subset of the experience tuples and a random Lagrangian multiplier from the set of Lagrangian multipliers. The random Lagrangian multiplier is then used to decompose the subset into subproblems to obtain target values for each subproblem. The target values are then used to train the DQN, which may be updated by using weights in gradient descent based on the experience tuples and the Lagrangian multipliers; and performing a gradient descent operation to update the DQN.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A method for training a reinforcement learning (RL) agent to solve weakly coupled Markov decision processes (WCMDPs), the method comprising:
at a deep RL agent, for each subproblem in a set of subproblems associated with a main problem, inputting weights, states, and a set of Lagrangian multipliers into a Deep Q-Network (DQN) to train the DQN to learn a Lagrangian action-value;
combining the subproblems to obtain an upper bound of the Lagrangian action-values;
using a greedy policy associated with the upper bound to determine an action;
in response to observing a transition experience associated with the action, storing experience tuples from interactions with the main problem in a replay buffer;
sampling both a subset of the experience tuples and a random Lagrangian multiplier from the set of Lagrangian multipliers;
using the random Lagrangian multiplier to decompose the subset into subproblems to obtain target values for each subproblem;
using the target values to train the DON; and
performing a gradient descent operation to update the DQN.

2. The method of claim 1, further comprising using a learned policy to make decisions in a real-world scenario without prior knowledge of an environment.

3. The method of claim 1, wherein the DON learns in a model-free setting.

4. The method of claim 1, further comprising using the random Lagrangian multiplier to incorporate linking constraints of the subproblems into an objective function.

5. The method of claim 4, further comprising applying a penalty for constraint violations through Lagrangian relaxation.

6. The method of claim 1, further comprising using the Lagrangian action-values to estimate an overall Lagrangian action-value function.

7. The method of claim 1, further comprising updating the DQN weights through gradient descent based on the experience tuples and the Lagrangian multipliers.

8. A non-transitory computer-readable medium for storing instructions for executing a process, the instructions comprising:
for each subproblem in a set of subproblems associated with a main problem, inputting weights, states, and a set of Lagrangian multipliers into a Deep Q-Network (DQN) to train the DQN to learn a Lagrangian action-value;
combining the subproblems to obtain an upper bound of the Lagrangian action-values;
using a greedy policy associated with the upper bound to determine an action;
in response to observing a transition experience associated with the action, storing experience tuples from interactions with the main problem in a replay buffer;
sampling both a subset of the experience tuples and a random Lagrangian multiplier from the set of Lagrangian multipliers;
using the random Lagrangian multiplier to decompose the subset into subproblems to obtain target values for each subproblem;
using the target values to train the DQN; and
performing a gradient descent operation to update the DQN.

9. The non-transitory computer-readable medium of claim 8, further comprising using a learned policy to make decisions in a real-world scenario without prior knowledge of an environment.

10. The non-transitory computer-readable medium of claim 8, wherein the DQN learns in a model-free setting.

11. The non-transitory computer-readable medium of claim 8, further comprising using the random Lagrangian multiplier to incorporate linking constraints of the subproblems into an objective function.

12. The non-transitory computer-readable medium of claim 11, further comprising applying a penalty for constraint violations through Lagrangian relaxation.

13. The non-transitory computer-readable medium of claim 8, further comprising using the Lagrangian action-values to estimate an overall Lagrangian action-value function.

14. The non-transitory computer-readable medium of claim 8, further comprising updating the DQN weights through gradient descent based on the experience tuples and the Lagrangian multipliers.

15. An apparatus, comprising:
a processor, configured to:
for each subproblem in a set of subproblems associated with a main problem, inputting weights, states, and a set of Lagrangian multipliers into a Deep Q-Network (DQN) to train the DQN to learn a Lagrangian action-value;
combining the subproblems to obtain an upper bound of the Lagrangian action-values;
using a greedy policy associated with the upper bound to determine an action;
in response to observing a transition experience associated with the action, storing experience tuples from interactions with the main problem in a replay buffer;
sampling both a subset of the experience tuples and a random Lagrangian multiplier from the set of Lagrangian multipliers;
using the random Lagrangian multiplier to decompose the subset into subproblems to obtain target values for each subproblem;
using the target values to train the DQN in a model-free setting; and
performing a gradient descent operation to update the DQN.

16. The method of claim 1, further comprising using a learned policy to make decisions in a real-world scenario without prior knowledge of an environment.

17. The method of claim 1, further comprising using the random Lagrangian multiplier to incorporate linking constraints of the subproblems into an objective function.

18. The method of claim 4, further comprising applying a penalty for constraint violations through Lagrangian relaxation.

19. The method of claim 1, further comprising using the Lagrangian action-values to estimate an overall Lagrangian action-value function.

20. The method of claim 1, further comprising updating the DQN weights through gradient descent based on the experience tuples and the Lagrangian multipliers.
